(19) United States
(12) Patent Application Publication
(10) Pub. No.: US 2016/0241062 A1
(43) Pub. Date: Aug. 18, 2016

(54) ELECTRICAL POWER CONVERTER CIRCUITS

(71) Applicant: Jeng-Jye Shau, Palo Alto, CA (US)

(72) Inventor: Jeng-Jye Shau, Palo Alto, CA (US)

(21) Appl. No.: 14/621,364

(22) Filed: Feb. 12, 2015

(51) Int. Cl. H02J 7/00; H02M 7/04

(52) U.S. Cl. CPC H02J 7/0044; H02M 7/04

(57) ABSTRACT

The preferred embodiments of the present invention changes the switch control mechanisms of switched-mode power converter circuits. Instead of controlling the duty cycle of switch control signals, the preferred embodiments of the present invention controls electrical switches based on the voltage level on the fire line of AC main power source. The resulting power converter circuits operates at better power efficiency while achieving significantly better space/cost efficiency, and they are small enough while powerful enough to be embedded into battery powered mobile devices.

### BACKGROUND OF THE INVENTION

The present invention relates to electrical power converter circuits, and more particularly to high efficiency power converter circuits that are small enough to be embedded into battery powered mobile devices.

The main power source, by definition, is the power source provided by utility power companies that are commonly accessible from power plugs on building walls. In United States, the main power sources are 110 volts 60 cycles/second alternative current (AC) power sources. In Europe, the main power sources are 220 volts 60 cycles/second AC. In other areas, the voltages of main power sources may vary between 100 to 240 volts, and the frequencies may vary between 50 to 60 volts. Most of main power sources transfer power using two power lines—a fire line that transfer power and a ground line that is connected to ground. Three-phase main power sources use two fire lines that are 120 degree out of phase, and one ground line. Most of electrical devices cannot use main power source directly. It is therefore necessary to use electrical power converter circuits to convert the power input from a main power source into proper waveforms suitable for electrical applications. An electrical power converter circuit, by definition, is an electrical circuit that draw power directly from main power sources while outputting power in a waveform to be used by other electrical devices.

Currently, most of commercial power converter circuits are switched-mode power converters. Switched-mode power converters use high frequency switching circuits to reduce the size of the components in output filters, and adjust the duty cycle (D) of the switch control signals to control the level of output voltages. FIG. 1(a) shows a simplified symbolic diagram for a prior art switched-mode power converter circuit called Buck converter. The power of this circuit is provided by an AC main power source (PW); the voltage at the fire line of PW is Vp, which is typically a sinusoid AC voltage source; the voltage at the ground line of PW is Vn, which is typically connected to ground, but it can be different from local ground. For the example in FIG. 1(a), the power lines of the AC main power source (PW) are connected through a PI filter (109) before they are connected to the input terminals of a bridge rectifier (BR); the voltage at the positive output terminal of BR is Vpi, and the voltage at the negative output terminal of BR is Vni. The output terminals of the bridge rectifier are connected to an input capacitor (Ci). The positive output terminal of the bridge rectifier is also connected to the drain terminal of a metal-oxide-semiconductor (MOS) transistor (101); the drain voltage of the transistor (101) is Vpi, the gate voltage of the transistor (101) is Vg, and the source voltage of the transistor (101) is Vs, as shown in FIG. 1(a). The source terminal of the MOS transistor is connected to the cathode of an electrical diode (102). The anode of the electrical diode is connected to the negative output terminal of the bridge rectifier (BR). The source terminal of the MOS transistor (101) is also connected to a terminal of an inductor (Lo), and the other terminal of the inductor is connected to a terminal of an electrical charge storage device (104) which is a capacitor in this example. The other terminal of the capacitor is connected to the negative output terminal of the bridge rectifier (BR), as shown in FIG. 1(a).

The key to achieve high power efficiency for switched-mode converter is that the MOS transistor (101) must be either fully on or fully off almost all the time. When the transistor (101) is fully on or fully off, the power consumed by the transistor is very small so that a high percentage of the power is transferred to the output instead of consumed by the converter circuit. Therefore, the gate-to-source voltage (Vg−Vs) should be a square wave such as the example shown in FIG. 1(b). For a Buck converter, at ideal condition, the output voltage (Vo−Vni) is related to the waveform of the gate-to-source voltage as (Vo−Vni)=D*(Vpi−Vni), where D=(Ton/(Ton+Toff)) is called “duty cycle”, Ton is the time when the MOS transistor is turned on in a period, and Toff is the time when the MOS transistor is turned off in a period, as illustrated in FIG. 1(b). Von in FIG. 1(b) is the gate to source voltage that is high enough to turn on the transistor (101), and Voff is the gate to source voltage that is low enough to turn off the transistor (101). The value of the output voltage (Vo−Vni) can be controlled by a duty cycle control circuit (108) which detects the level of the output voltage using a sensing circuit (107) as a feedback to determine the value of D, and generate the gate voltage (Vg−Vs) of the MOS transistor (101) to control the level of the output voltage (Vo−Vni), as shown in FIG. 1(a, b).

Besides Buck converters, a wide varieties of switch-mode converters, such as the Boost converter, the Buck-Boost converters, and many other switch-mode power converter circuits have been developed. The book “Fundamental of Power Electronics” authored by Erickson and Maksimovic is one of many publications that introduced switched-mode converters. Those prior art switched-mode converters work very well relative to prior art linear converters. With careful designs, switch-mode converters can reach power efficiency above 90%. Power converters as small as a few cubic inches also can be made using switch-mode converter circuits.

However, prior art switched-mode converters have many limitations. Isolated converters uses transformers, but the transformers are typically large and heavy. Non-isolated switched-mode converters, such as the example in FIG. 1(a), avoid using transformers to achieve smaller sizes, but they still have many problems. One problem is that the instantaneous current flow through the inductor (Lo) is much higher than the output current, which causes power lost due to the none-ideal resistance of the inductor. The other problem is that the inductor (Lo) causes voltage overshoots during switching events, which create high voltage stresses on the transistor (101). It is therefore necessary to use a special transistor that can survive voltage stress as high as 700 volts. Such high voltage transistors are less efficient and more expensive than low voltage transistors. One solution to solve these two problems is to use an inductor with large inductance, but such inductor would be large, heavy, and expensive. The other solution is to increase the frequency of the switching gate control signals. However, increasing switching frequency increases power lost due to switching circuits. Operating at high frequency also causes electromagnetic interference (EMI). It is therefore often necessary for prior art switched-mode converters to use PI filters (109) to reduce EMI effects. The PI filter is an electromagnetic device that can be heavy, bulky, and expensive. It is therefore highly desirable to develop power converter circuits that do not need to use inductors while achieving high efficiency. It is also highly desirable to develop power transfer circuits that do not need to operate at high frequencies so that EMI regulations can be fulfilled naturally without using a PI filter.

For prior art switched-mode converters, the input capacitor (Ci) is another major problem. The input capacitor (Ci) needs to tolerate the full stress of the peak voltage amplitude of the AC main power source (PW), and it also need to have a high capacitance value in order to be useful. Such large capacitance high voltage capacitors are typically large and expensive. In addition, with an input capacitor, the power source only provides current when the fire line voltage is near peak amplitudes, which causes disturbance in the power network. It is therefore highly desirable to avoid using large input capacitors.

Power efficiency, size, and weight of electrical components are extremely important for battery powered mobile devices such as mobile phones, note pad computers, lap top computers, electrical books, and digital cameras. Switched-mode power converters are the most successful prior art power converters, but switched-mode power converters are not able to meet the requirements to be embedded in current art mobile devices due to the above limitations. It is highly desirable to develop power converter circuits that can be embedded into battery powered mobile devices so that there will be no need to use external power converter circuits.

### SUMMARY OF THE PREFERRED EMBODIMENTS

A primary objective of the preferred embodiments is, therefore, to improve size, weight, cost, and power efficiency of power converter circuits. An objective of the preferred embodiment is to reduce the voltage stress on electrical components used in power converter circuits. Another objective of the preferred embodiment is to reduce the switching frequency of the switches used by power converter circuits, and therefore reduce EMI. Another primary objective of the preferred embodiments is to provide power converter circuits that can be embedded into battery powered mobile devices. These and other objectives are assisted by controlling the switch inside a power converter circuit according to the voltage levels of the main power source, instead of controlling the duty cycles of the switching signals.

While the novel features of the invention are set forth with particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1(a) is a simplified symbolic diagram illustrating the structures of a prior art Buck converter;

FIG. 1(b) shows a typical waveform for the gate-to-source voltage of the transistor (101) used by the prior art Buck converter in FIG. 1(a);

FIG. 2(a) is a simplified symbolic diagram illustrating the structures of an exemplary embodiment of a power converter circuit of the present invention;

FIG. 2(b) shows an example when the electrical switch (205) in FIG. 2(a) is implemented by one diode (203) and one transistor (201);

FIGS. 2(c-f) are examples of voltage waveforms illustrating the operation of the power converter circuit in FIG. 2(b);

FIG. 3(a) is a simplified symbolic diagram illustrating the structures of an exemplary embodiment of a power converter circuit of the present invention that do not use bridge rectifier;

FIGS. 3(b-d) are examples of voltage waveforms illustrating the operations of the electrical converter circuit in FIG. 3(a);

FIG. 3(e) is a simplified symbolic diagram illustrating the structures of an exemplary embodiment of a power converter circuit of the present invention that is the same as the power converter circuit in FIG. 3(a) except that it has one additional diode (353) in the electrical switch (355);

FIG. 3(f) is a simplified symbolic diagram illustrating the structures of an exemplary embodiment of a power converter circuit of the present invention that is the same as the power converter circuit in FIG. 3(a) except that it has one additional resistor (366) in the electrical switch (365);

FIG. 4(a) is a simplified symbolic diagram illustrating the structures of an exemplary embodiment of a power converter circuit of the present invention that works on negative voltages;

FIGS. 4(b-d) are voltage waveforms illustrating the operations of the electrical converter circuit in FIG. 4(a);

FIGS. 5(a-c) are simplified symbolic diagrams illustrating the structures of an exemplary embodiment of a power converter circuit of the present invention that uses a configurable charge storage device (504);

FIGS. 5(d-g) are voltage waveforms illustrating the operations of the electrical converter circuit in FIGS. 5(a-c);

FIGS. 6(a-d) are simplified symbolic diagrams illustrating the structures of exemplary embodiments of configurable charge storage devices;

FIGS. 7(a-d) are simplified symbolic diagrams illustrating the structures of an exemplary embodiment of a power converter circuit of the present invention that uses the configurable charge storage device illustrated in FIG. 6(d);

FIGS. 7(e-g) are voltage waveforms illustrating the operations of the electrical converter circuit in FIGS. 7(a-d);

FIG. 8 is a simplified symbolic diagram illustrating the structures of an exemplary embodiment of a power converter circuit of the present invention that comprises many electrical switches (811-814);

FIGS. 9(a-c) are waveforms illustrating the current-voltage relationship for exemplary embodiments of the present invention;

FIG. 10(a) illustrates an exemplary embodiment of the present invention when the power converter circuit is implemented as one packaged electrical component (911) plus one capacitor (912); and

FIG. 10(b) illustrates an exemplary embodiment of the present invention when the power converter circuit is embedded into a battery powered electrical mobile device.

### DETAILED DESCRIPTION OF THE PREFERRED EMBODIMENTS

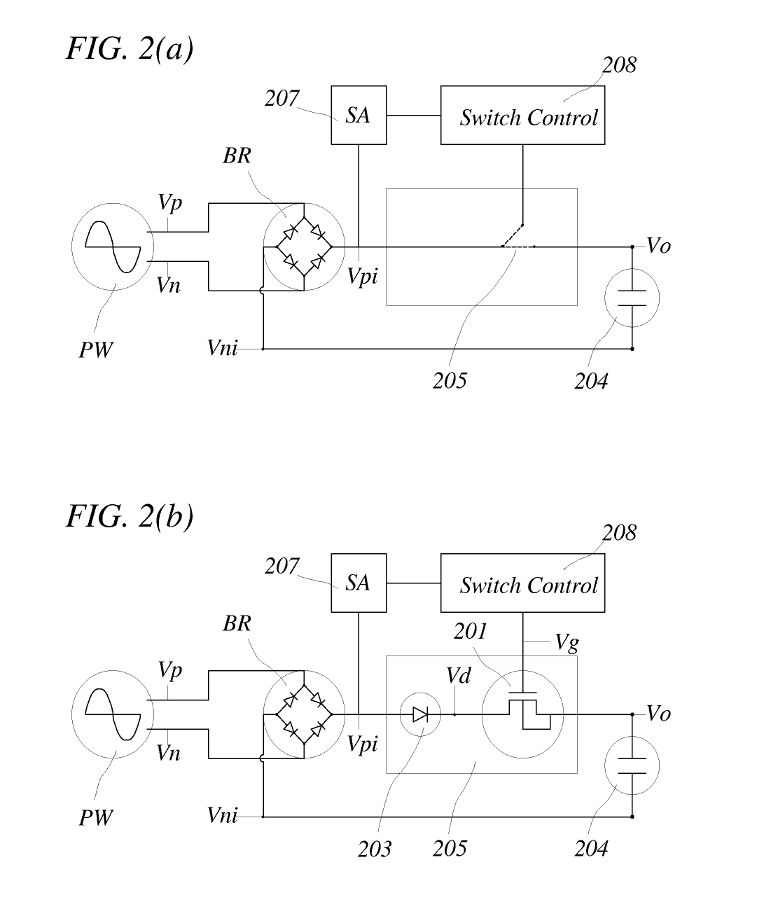

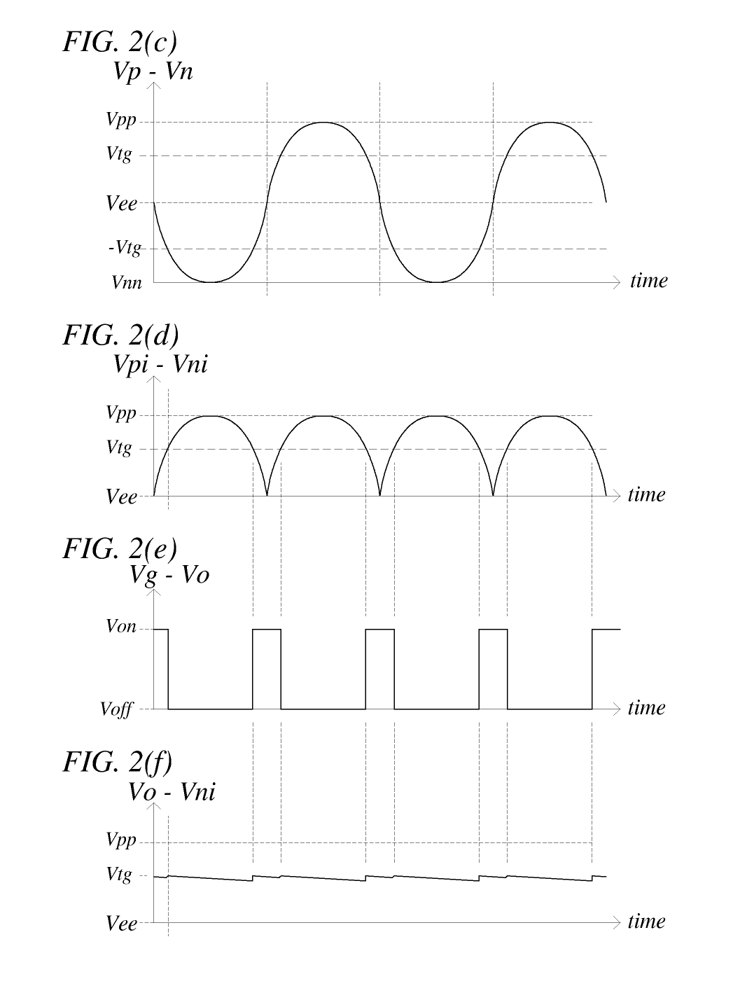

FIG. 2(a) shows a simplified symbolic diagram for an exemplary embodiment of a power converter circuit of the present invention. The power lines of AC main power source (PW) are connected through electrical input connections, which are shown symbolically as solid lines that are connected to PW, to the input terminals of a bridge rectifier (BR); the voltage at the fire line of PW is Vp, the voltage at the ground line of PW is Vn, the voltage at the positive output terminal of BR is Vpi, and the voltage at the negative output terminal of BR is Vni, as shown in FIG. 2(a). In this example, the positive output terminal of the bridge rectifier is connected through an electrical switch (205) to a terminal of an electrical charge storage device (204). The other terminal of the charge storage device (204) is connected to the negative output terminal of the bridge rectifier (BR). This electrical switch (205) controls the electrical impedance between the electrical power input connection to the electrical charge storage device (204) so that, when the electrical switch is turned on, a low impedance electrical current path can be formed from the fire line of the main power source (PW) to the electrical charge storage device (204), and, when the electrical switch is turned off, the charge storage device is substantially decoupled from the fire line. By definition, an electrical charge storage device comprises one charge storage component or a plurality of charge storage components, where a charge storage component is either a capacitor or a battery.

The electrical switch (205) is controlled by a switch control circuit (208) that uses a sensing circuit (207) to sense the voltage (Vpi−Vni) between the output terminals of the bridge rectifier (BR), and determines when to turn on or turn off the electrical switch (205). This electrical switch control circuit (208) turns on or turns off the electrical switch (205) in order to control the voltage on the charge storage device (204) toward a target storage voltage (Vtg), where the electrical switch control circuit (208) turns on the electrical switch (205) when the voltage on the fire line is at a level that can change the voltage applied on the charge storage device toward Vtg, and turns off the electrical switch (205) when the voltage on the fire line is at a level that can change the voltage applied on said charge storage device away from Vtg. The sensing circuit (307) may or may not measure the voltage directly on the fire line to achieve the purpose. For case in FIG. 2(a, b), the sensing circuit (307) measures (Vpi−Vni) as an indirect method to determine whether the voltage level on the fire line will drive the voltage on the charge storage device (204) toward or away from Vtg.

The electrical switch (205) in FIG. 2(a) can be implemented in many ways. FIG. 2(a) shows an implementation when the electrical switch in FIG. 2(a) comprises a diode (203) connected in series with an MOS transistor (201). The positive output terminal of the bridge rectifier is connected to the anode of the diode (203). The cathode of the diode (203) is connected to the drain terminal of the transistor (201). The gate terminal of the transistor (201) is controlled by the switch control circuit (208), and the source terminal of the transistor (201) is connected to a terminal of the charge storage device (204), as shown in FIG. 2(b). The drain voltage of the transistor (201) is Vd, the gate voltage of the transistor (201) is Vg, and the source voltage of the transistor (201) is Vo, as shown in FIG. 2(b). Vo may or may not be the output of the circuit, depends on the application.

The voltage difference (Vp−Vn) between the power lines of the main power source (PW) in FIG. 2(b) is typically a sinusoid wave swinging between a positive peak voltage (Vpp) and a negative peak voltage (Vnn), as shown in FIG. 2(c). The voltage value Vee in FIG. 2(c) represents the average voltage value of the AC power source (PW), which is typically around ground voltage, but it can be different from local ground voltage. For clarity, the voltage waveforms in our drawings are not always drawn to scale, and detailed voltage differences caused by diode voltage drops or voltage drops across small impedances are typically not draw to scale in our figures. Noise in the waveforms are also not drawn to scale in our figures. Those detailed differences are well known to people who are familiar with the art of circuit design. Our figures and discussions do not show those details for clarity in understanding the novel features of our examples.

The voltage difference (Vpi−Vni) between the output terminals of the bridge rectifier (BR) in FIG. 2(b) is illustrated by the simplified waveform in FIG. 2(d). The target voltage (Vtg) is also marked in FIG. 2(d). When the rectified voltage (Vpi−Vni) is at Vtg, the main power source voltage (Vp−Vn) is near Vtg or −Vtg, as shown in FIG. 2(c). The switch control circuit (208) in FIG. 2(b) senses the voltage (Vpi−Vni), and generates the gate-to-source voltage on the transistor (201) as shown in FIG. 2(e). When the voltage (Vpi−Vni) is lower than Vtg, that is, when the voltage on the fire line of the main power source is between Vtg and −Vtg, the switch control circuit (208) applied a voltage Von as gate-to-source voltage (Vg−Vo) on the transistor (201) to turn on the transistor, as illustrated by the waveform in FIG. 2(e). For the example in FIG. 2(b), when the transistor (201) is turned on, the diode (203) in the electrical switch (205) determines the current flow. The diode (203) is turned on when (Vpi−Vni) is higher than the voltage (Vo−Vni) on the charge storage device (204), and change (Vo−Vni) toward the target voltage Vtg; the diode (203) is turned off when (Vpi−Vni) is lower than (Vo−Vni), and it will try to prevent the voltage (Vo−Vni) on the charge storage device (204) from changing away from Vtg. When the voltage (Vpi−Vni) is higher than Vtg, that is, when the voltage on the fire line of the main power source is higher than Vtg or lower than −Vtg, the switch control circuit (208) applies a voltage Voff as the gate-to-source voltage (Vg−Vo) on the transistor (201) to turn off the transistor, trying to prevent the voltage on the charge storage device from changing away from Vtg, as illustrated by the waveform in FIG. 2(e). In these ways, the electrical switch control circuit (208) turns on the electrical switch (205) when the voltage on the fire line is at a level that can change the voltage applied on the charge storage device (204) toward Vtg, and turns off the electrical switch (205) when the voltage on the fire line is at a level that can change the voltage applied on the charge storage device (204) away from Vtg. Therefore, the voltage (Vo−Vni) on the charge storage device (204) stays around Vtg, as illustrated by the waveform shown in FIG. 2(f). The effects of leakage current, noise, or loading may change (Vo−Vni) away from Vtg; those effects are not shown in details for clarity reason.

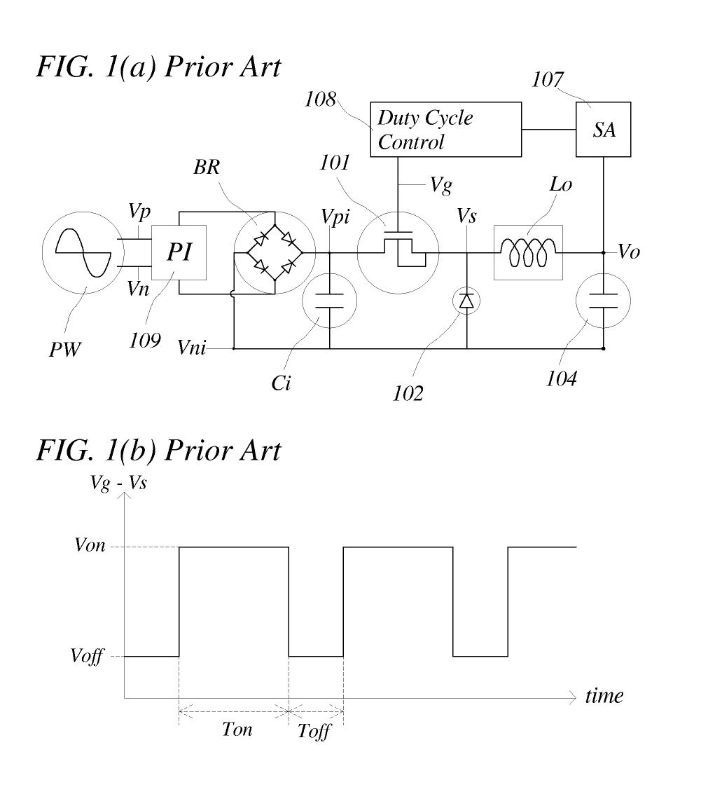

The power converter circuit in FIG. 2(b) has many advantages over prior art switched-mode power converter circuits. The electrical switch (205) is either fully on or fully off almost all the time to achieve high power efficiency. Comparing with prior art switched-mode power converter circuits such as the example in FIG. 1(a), the power converter circuits of the present invention can operate at much lower frequencies, so that the power lost due to switching components are reduced significantly. Therefore, the power converter circuits of the present invention is able to achieve better power efficiency than prior art circuits. Because of low frequency operations, there is no need to use a PI filter for EMI protection. That further reduce the size and the cost of our circuits. The target voltage is controlled by turning on the electrical switch (205) when the fire line voltage is right, and there is no need to use an inductor to achieve that purpose. Removing the need for large inductors further reduce size and cost. Since there is no longer voltage overshoots caused by inductors, the voltage stress on the electrical switch (205) is much lower than the voltage stress caused by prior art switched-mode converter circuits. It is therefore possible to use electrical switches that are better in power efficiency as well as in cost efficiency. There is no need to use an input capacitor (Ci), which further reduce size and cost. The electrical switch (205), the switch control circuit (208), plus most of the electrical components used in FIG. 2(b), can be integrated into the same semiconductor substrate and/or packaged into a single electrical component. The size of the circuits in FIG. 2(b) can be small enough to be embedded into a battery powered electrical mobile device, while the circuit can achieve better power efficiency and provide more power than prior art power converter circuits.

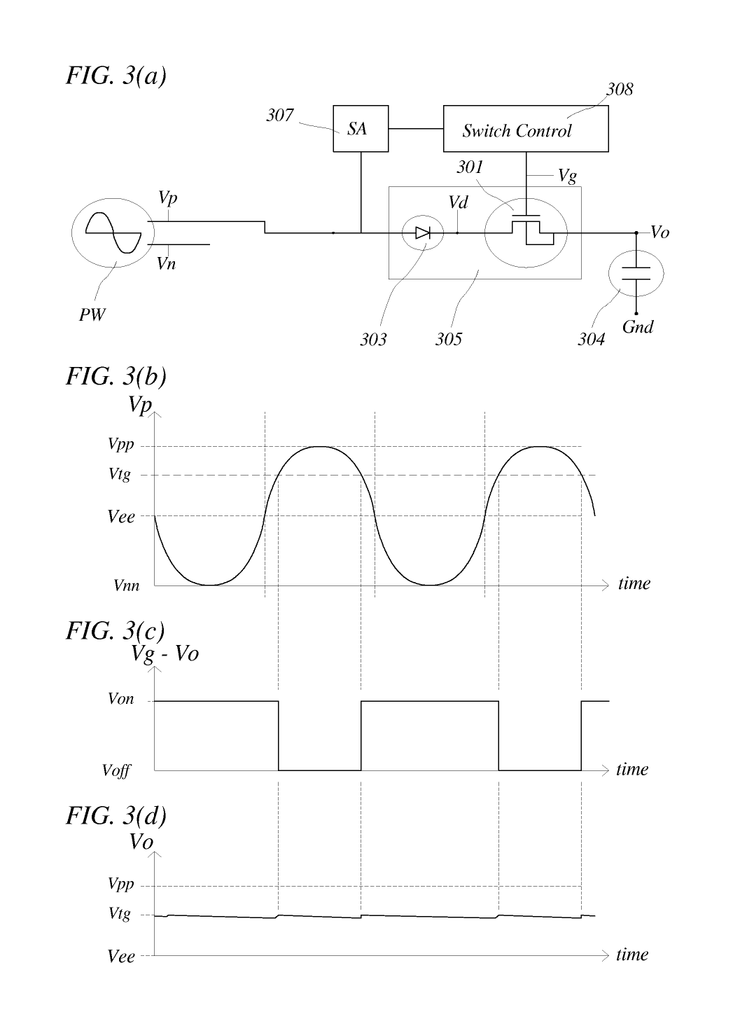

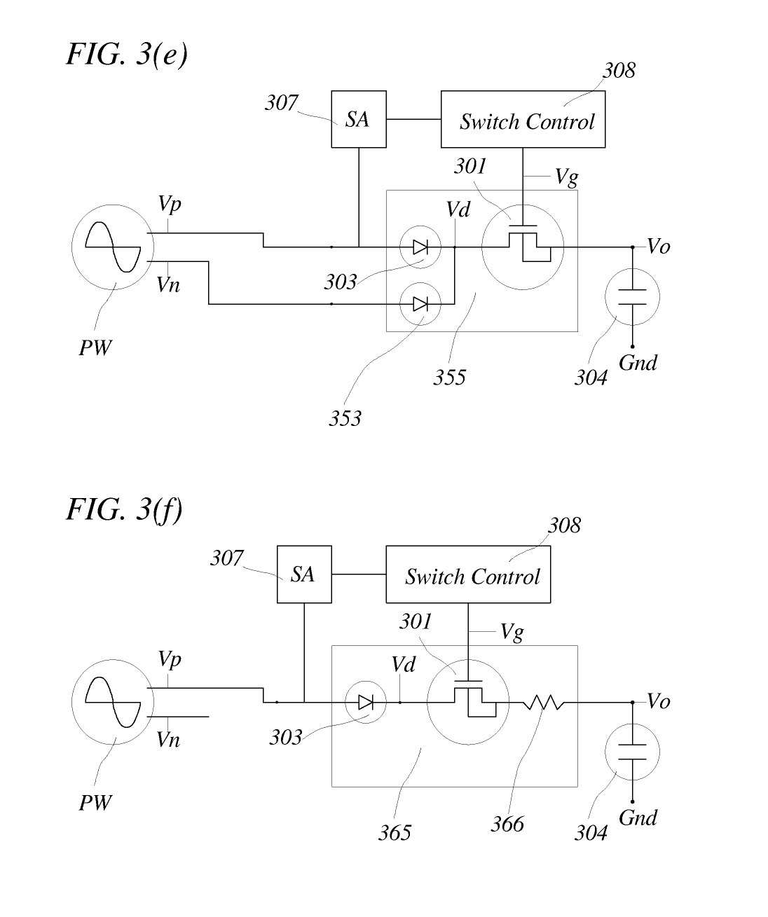

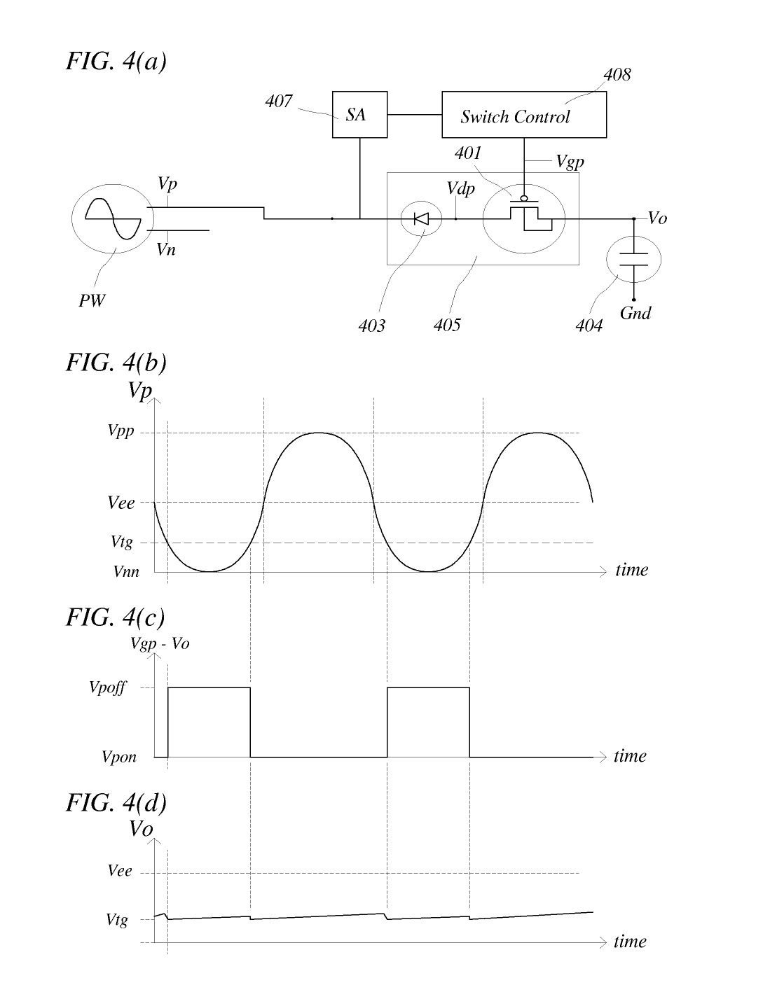

While the preferred embodiments have been illustrated and described herein, other modifications and changes will be evident to those skilled in the art. It is to be understood that there are many other possible modifications and implementations so that the scope of the invention is not limited by the specific embodiments discussed herein. For examples, the electrical switch (205) can be implemented in many ways; it can be a diode, a transistor, a diode plus a transistor, a plurality of diodes, a plurality of transistors, bipolar transistor(s), PNPN device(s), part of or all of a bridge rectifier, and many other circuit implementations. The sensing circuit (207) can detect the voltage on the fire line directly, also can detect the voltage indirectly. The target voltage can be a positive or negative voltage; the target voltage can be significantly different from the peak voltages of the main power source, or close to the peak voltages. The voltage waveform on the charge storage device can be near constant, and it also can be a complex waveform. The switch control circuit also can sense the output voltage as part of the factors used to determine the target voltage or the control mechanisms. The above examples use a bridge rectifier (BR) while it is also possible not to use a bridge rectifier, as shown by the examples in FIG. 3(a) and in FIG. 4(a).

FIG. 3(a) shows a simplified symbolic diagram for an exemplary embodiment of a power converter circuit of the present invention that has similar structures as the example shown in FIG. 2(b) except that the fire line of AC main power source (PW) connected to an electrical input connection is directly connected through an electrical switch (305) to a terminal of an electrical charge storage device (304) without using a bridge rectifier, and the other terminal of the charge storage device (304) is connected to ground (Gnd). The electrical switch (305) in FIG. 3(a) also comprises a diode (303) connected in series with an MOS transistor (301). The electrical input connection connected to the fire line of main power source (PW) is connected to the anode of the diode (303). The cathode of the diode (303) is connected to the drain terminal of the transistor (301). The gate terminal of the transistor (301) is controlled by a switch control circuit (308), and the source terminal of the transistor (301) is connected to a terminal of the charge storage device (304), as shown in FIG. 3(a). The fire line voltage is Vp, the drain voltage of the transistor (301) is Vd, the gate voltage of the transistor (301) is Vg, and the source voltage of the transistor (301) is Vo, as shown in FIG. 3(a). The electrical switch (305) is controlled by a switch control circuit (308) that uses a sensing circuit (307) to sense the voltage Vp and determines when to turn on or turn off the electrical switch (305). This electrical switch control circuit (308) turns on or turns off the electrical switch (305) in order to control the voltage on the charge storage device (304) toward a target storage voltage (Vtg).

The waveform of the voltage (Vp) on the fire line of the power source (PW) is shown in FIG. 3(b). The target voltage (Vtg) is also marked in FIG. 3(b). When Vp is lower than Vtg, the switch control circuit (308) applies a voltage Von as the gate-source voltage (Vg−Vo) on the transistor (301) to turn on the transistor, as illustrated by the waveform in FIG. 3(c). When the transistor (301) is turned on, the diode (303) in the electrical switch (305) determines the current flow. The diode (303) is turned on when Vp is higher than the voltage Vo on the charge storage device (304), and change Vo toward the target voltage Vtg; the diode (303) is turned off when Vp is lower than Vo, and it will try to prevent the voltage (Vo) on the charge storage device (304) from changing away from Vtg. When Vp is higher than Vtg, the switch control circuit (308) applies gate voltage Voff on the transistor (301) to turn off the transistor, trying to prevent the voltage on the charge storage device from changing away from Vtg, as illustrated by the waveform in FIG. 3(c). In these ways, the electrical switch control circuit (308) turns on the electrical switch (305) when the voltage on the fire line is at a level that can change the voltage applied on the charge storage device (304) toward Vtg, and turns off the electrical switch (305) when the voltage on the fire line is at a level that can change the voltage applied on the charge storage device (304) away from Vtg. Therefore, the voltage (Vo) on the charge storage device (304) stays around Vtg, as illustrated by the waveform shown in FIG. 3(d). The effects of leakage current, noise, or loading may change Vo away from Vtg; those effects are not shown in details for clarity reason.

The power converter circuit in FIG. 3(a) can be smaller than that in FIG. 2(b) because it does not use a bridge rectifier, and it has automatic galvanic isolation because all voltages are relative to local ground (Gnd) without referring to power ground line. The disadvantage is that the charge storage device (304) is charged twice per power cycle instead of 4 times per power cycle.

While the preferred embodiments have been illustrated and described herein, other modifications and changes will be evident to those skilled in the art. For example, FIG. 3(e) shows a circuit that is the same as the power converter circuit in FIG. 3(a) except that it has one additional diode (353) in the electrical switch (355). This diode (353) is connected to the ground line of the main power source (PW). The circuit in FIG. 3(a) does not function if the user plugs the power plug in the wrong way while the circuit in FIG. 3(e) functions when the connections to the power lines are swapped. For another example, FIG. 3(e) shows a circuit that is the same as the power converter circuit in FIG. 3(a) except that it has one additional resistor (366) in the electrical switch (365) that is connected between the source terminal of the transistor (301) and the input terminal of the charge storage device (304). This resistor (366) provides surge protection. The resistance of this resistor (366) should be small enough to cause minimal influence in normal operation while large enough to turn off the transistor (301) when there is a power surge on the main power source (PW). The above examples are simplified for clarity while there may be many other electrical components used in actual circuits. For example, we may still use an inductor connected between the electrical switch (305) and the charge storage device (304) to serve the functions of a filter. The switch control circuit may sense the voltage Vo as a feedback for better control. Instead of turning on the transistor (301) whenever Vp is lower than Vtg, the switch control circuit (308) may apply a high frequency signal to turn the gate voltage on and off as a method to provide larger output current. Other circuits maybe inserted in the input stages or output stages. It is to be understood that there are many other possible modifications and implementations so that the scope of the invention is not limited by the specific embodiments discussed herein.

The target voltages in the above examples were positive voltages, while the example shown in FIG. 4(a) operates on negative target voltages. FIG. 4(a) shows a simplified symbolic diagram for an exemplary embodiment of a power converter circuit of the present invention that has similar structures as the example shown in FIG. 3(a) except the structures of the electrical switch (405). The electrical switch (405) in FIG. 4(a) also comprises a diode (403) connected in series with an MOS transistor (401) but the polarity of the diode is reversed, and the MOS transistor (401) is a p-channel transistor instead of an n-channel transistor. The electrical input connection connected to the fire line of main power source (PW) is connected to the cathode of the diode (403). The anode of the diode (403) is connected to the drain terminal of the p-channel MOS transistor (401). The gate terminal of the transistor (401) is controlled by a switch control circuit (408), and the source terminal of the transistor (401) is connected to a terminal of the charge storage device (404), as shown in FIG. 4(a). The fire line voltage is Vp, the drain voltage of the transistor (401) is Vdp, the gate voltage of the transistor (401) is Vgp, and the source voltage of the transistor (401) is Vo, as shown in FIG. 4(a). The electrical switch (405) is controlled by a switch control circuit (408) that uses a sensing circuit (407) to sense the voltage Vp and determines when to turn on or turn off the electrical switch (405). This electrical switch control circuit (408) turns on or turns off the electrical switch (405) in order to control the voltage on the charge storage device (404) toward a target storage voltage (Vtg).

The waveform of the voltage (Vp) on the fire line of the power source (PW) is shown in FIG. 4(b). The target voltage (Vtg) is also marked in FIG. 4(b), which is a negative voltage in this example. When Vp is higher than Vtg, the switch control circuit (408) applies a voltage Vpon as the gate-source voltage (Vgp−Vo) on the transistor (401) to turn on the transistor, as illustrated by the waveform in FIG. 4(c). When the transistor (401) is turned on, the diode (403) in the electrical switch (405) determines the current flow. The diode (403) is turned on when Vp is lower than the voltage Vo on the charge storage device (404), and change Vo toward the target voltage (Vtg); the diode (403) is turned off when Vp is higher than Vo, and it will prevent the voltage (Vo) on the charge storage device (404) from changing away from Vtg. When Vp is lower than Vtg, the switch control circuit (408) applies gate voltage Vpoff on the transistor (401) to turn off the transistor, trying to prevent the voltage on the charge storage device from changing away from Vtg, as illustrated by the waveform in FIG. 4(c). In these ways, the electrical switch control circuit (408) turns on the electrical switch (405) when the voltage on the fire line is at a level that can change the voltage applied on the charge storage device (404) toward Vtg, and turns off the electrical switch (405) when the voltage on the fire line is at a level that can change the voltage applied on the charge storage device (404) away from Vtg. Therefore, the voltage (Vo) on the charge storage device (404) stays around Vtg, as illustrated by the waveform shown in FIG. 4(d). The effects of leakage current, noise, or loading may change Vo away from Vtg; those effects are not shown in details for clarity reason.

While the preferred embodiments have been illustrated and described herein, other modifications and changes will be evident to those skilled in the art. It is to be understood that there are many other possible modifications and implementations so that the scope of the invention is not limited by the specific embodiments discussed herein. For examples, the target voltage Vtg in the above examples was set on a single value, while the target voltage can be set on multiple values, or set as a complex function.

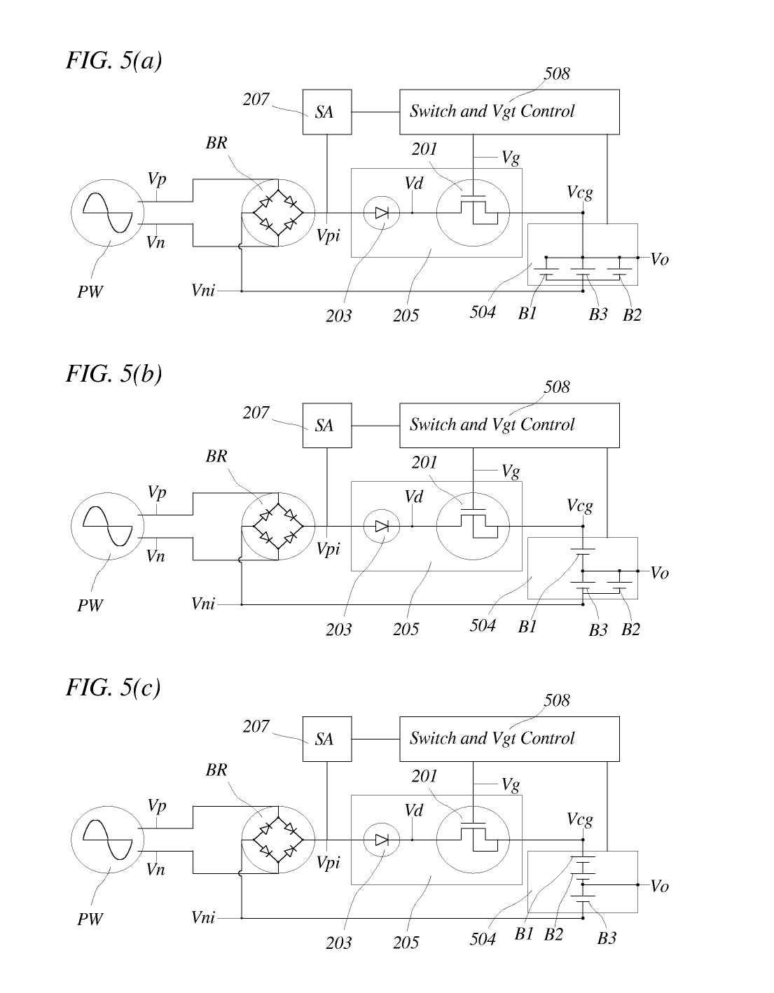

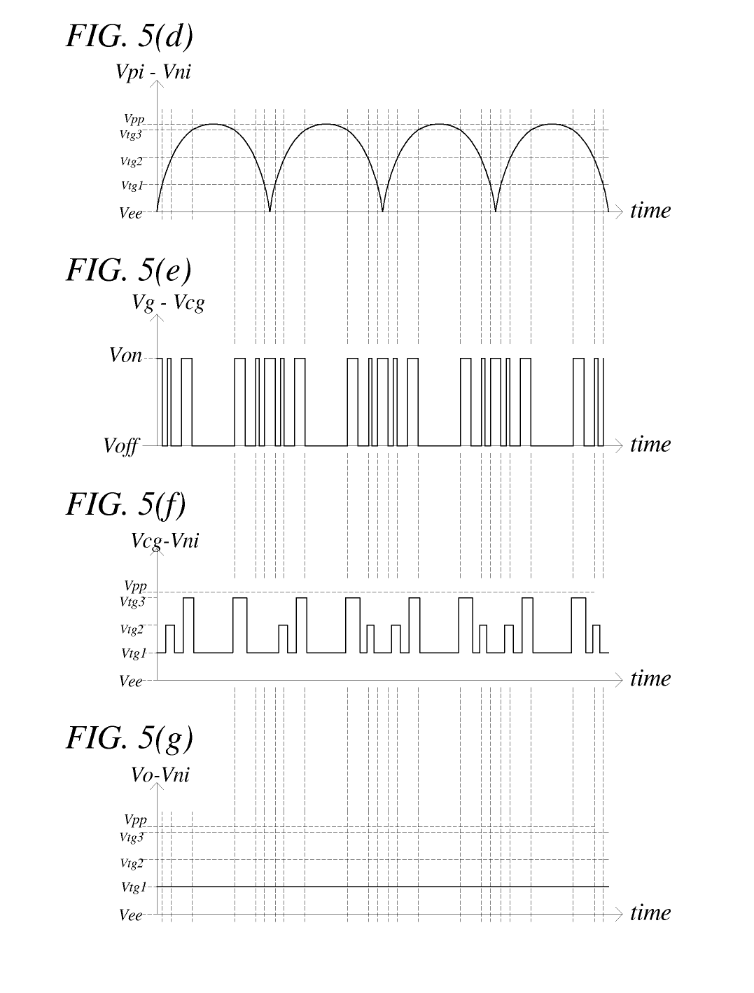

FIGS. 5(a-c) shows simplified symbolic diagrams for an exemplary embodiment of a power converter circuit of the present invention that has the same structures as the example in FIG. 2(b) except that the charge storage device (204) in FIG. 2(b) is replaced by a configurable charge storage device (504), and the switch control circuit (508) not only controls the operations of the electrical switch (205) but also controls the configuration of the configurable charge storage device (504). The terminal of this charge storage device (504) that is connected to the source terminal of the transistor (201) is at a voltage Vcg, and the other terminal is connected to the negative output terminal of the bridge rectifier (BR) at voltage Vni, as shown in FIGS. 5(a-c).

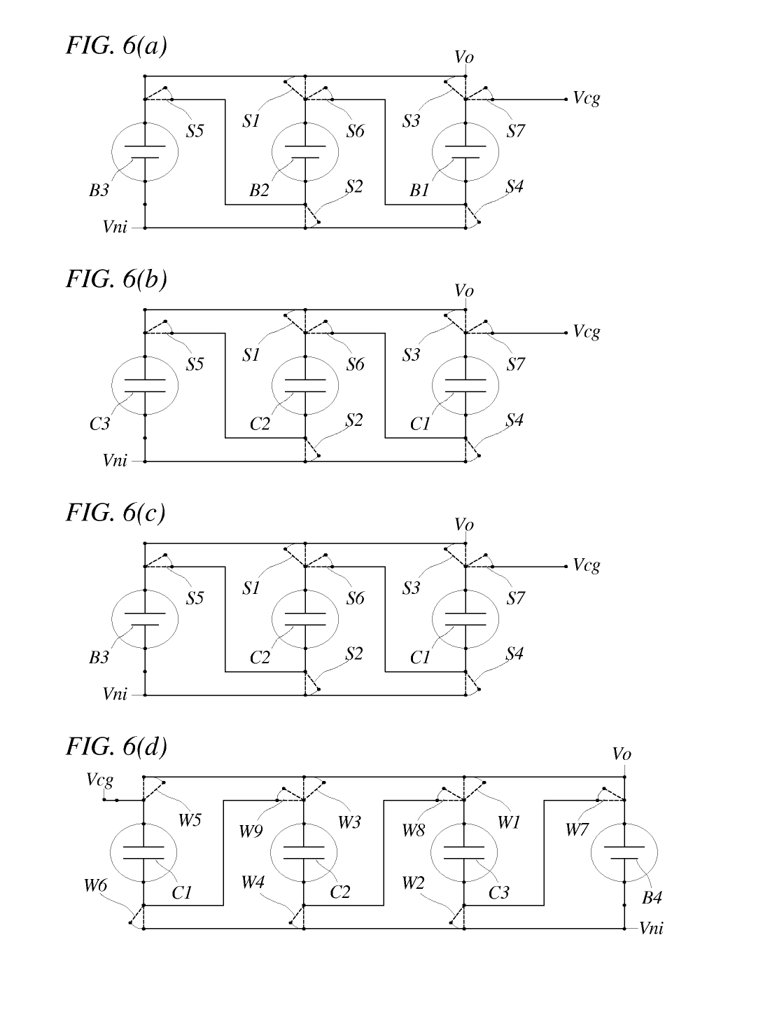

FIG. 6(a) is a simplified symbolic diagram for the configurable charge storage device (504) in FIGS. 5(a-c). This charge storage device (504) comprises three batteries (B1-B3) and 7 electrical switches (S1-S7). By controlling the status of those electrical switches (S1-S7), this charge storage device can be arranged in different configurations. For examples, when switches S1, S2, S3, and S4 are turned on, and when switches S5, S6, and S7 are turned off, the charge storage device (504) is configured as three batteries (B1-B3) connected in parallel, as illustrated by FIG. 5(a); when switches S1, S2, S6, and S7 are turned on, and when switches S3, S4, and S5 are turned off, B2 and B2 are connected in parallel while B1 is connected in series with them, as illustrated by FIG. 5(b); when switches S5, S6, and S7 are turned on, and when switches S1, S2, S3, and S4 are turned off, the charge storage device (504) is configured as three batteries (B1-B3) connected in series, as illustrated by FIG. 5(c).

The electrical switch (205) is controlled by a switch control circuit (508) that uses a sensing circuit (207) to sense the voltage (Vpi−Vni) between the output terminals of the bridge rectifier (BR) and determines when to turn on or turn off the electrical switch (205) as well as determining the configuration of the configurable charge storage device (504). This electrical switch control circuit (508) turns on or turns off the electrical switch (505) in order to control the voltage on the charge storage device (504) toward target voltages at three different target voltage levels (Vtg1-Vtg3) which are dependent on the configurations of the charge storage device (504). When the charge storage device is configured as shown in FIG. 5(a), the electrical switch control circuit (508) turns on the electrical switch (205) when the voltage on the fire line is at a level that can change the voltage applied on the charge storage device toward Vtg1, and turns off the electrical switch (205) when the voltage on the fire line is at a level that can change the voltage applied on said charge storage device away from Vtg1. When the charge storage device is configured as shown in FIG. 5(b), the electrical switch control circuit (508) turns on the electrical switch (205) when the voltage on the fire line is at a level that can change the voltage applied on the charge storage device toward Vtg2, and turns off the electrical switch (205) when the voltage on the fire line is at a level that can change the voltage applied on said charge storage device away from Vtg2. When the charge storage device is configured as shown in FIG. 5(c), the electrical switch control circuit (508) turns on the electrical switch (205) when the voltage on the fire line is at a level that can change the voltage applied on the charge storage device toward Vtg3, and turns off the electrical switch (205) when the voltage on the fire line is at a level that can change the voltage applied on said charge storage device away from Vtg3.

The voltage difference (Vpi−Vni) between the output terminals of the bridge rectifier (BR) in FIGS. 5(a-c) is illustrated by the simplified waveform in FIG. 5(d). The target voltages (Vtg1-Vtg3) are also marked in FIG. 5(d). The switch control circuit (508) uses the sensing circuit (207) to detect the voltage level of (Vpi−Vni), and determines the operation of the electrical switch (205) as well as the configuration of the charge storage device (504). When the voltage (Vpi−Vni) is lower than Vtg1, the charge storage device (504) is configured as that shown in FIG. 5(a), and the switch control circuit (508) applies a voltage Von as gate-to-source voltage (Vg−Vcg) on the transistor (201) to turn on the transistor, as illustrated by the waveform in FIG. 5(e). When the transistor (201) is turned on, the diode (203) in the electrical switch (205) determines the current flow. The diode (203) is turned on when (Vpi−Vni) is higher than the voltage (Vcg−Vni) on the charge storage device (504), and change (Vcg−Vni) toward the target voltage Vtg1; the diode (203) is turned off when (Vpi−Vni) is lower than (Vcg−Vni), and it will try to prevent the voltage (Vcg−Vni) on the charge storage device (504) from changing away from Vtg1. When the voltage (Vpi−Vni) is higher than Vtg1 and when the charge storage device (504) is configured as shown in FIG. 5(a), the switch control circuit (508) applies a voltage Voff as the gate-to-source voltage (Vg−Vo) on the transistor (201) to turn off the transistor, preventing the voltage on the charge storage device from changing away from Vtg1, as illustrated by the waveform in FIG. 5(e). It is also possible to achieve the same results by changing the configuration of the charge storage device (504) before turning off the transistor (201). In these ways, the electrical switch control circuit (508) turns on the electrical switch (205) when the voltage on the fire line is at a level that can change the voltage applied on the charge storage device (504) toward Vtg1, and turns off the electrical switch (205) when the voltage on the fire line is at a level that can change the voltage applied on the charge storage device (504) away from Vtg1. Therefore, the voltage (Vcg−Vni) on the charge storage device (504) stays around Vtg1, as illustrated by the waveform shown in FIG. 5(f).

When the voltage (Vpi−Vni) is higher than Vtg1 but lower than Vtg2, the charge storage device (504) is configured as that shown in FIG. 5(b), and the switch control circuit (508) applies a voltage Von as gate voltage-to-source voltage (Vg−Vcg) on the transistor (201) to turn on the transistor, as illustrated by the waveform in FIG. 5(e). When the transistor (201) is turned on, the diode (203) in the electrical switch (205) determines the current flow. The diode (203) is turned on when (Vpi−Vni) is higher than the voltage (Vcg−Vni) on the charge storage device (504), and it will try to change (Vcg−Vni) toward the target voltage Vtg2; the diode (203) is turned off when (Vpi−Vni) is lower than (Vcg−Vni), and it will try to prevent the voltage (Vcg−Vni) on the charge storage device (504) from changing away from Vtg2. When the voltage (Vpi−Vni) is higher than Vtg2 and when the charge storage device (504) is configured as shown in FIG. 5(b), the switch control circuit (508) applies a voltage Voff as the gate-to-source voltage (Vg−Vo) on the transistor (201) to turn off the transistor, preventing the voltage on the charge storage device from changing away from Vtg2, as illustrated by the waveform in FIG. 5(e). It is also possible to achieve the same results by changing the configuration of the charge storage device (504) before turning off the transistor (201). In these ways, the electrical switch control circuit (508) turns on the electrical switch (205) when the voltage on the fire line is at a level that can change the voltage applied on the charge storage device (504) toward Vtg2, and turns off the electrical switch (205) when the voltage on the fire line is at a level that can change the voltage applied on the charge storage device (504) away from Vtg2. Therefore, the voltage (Vcg−Vni) on the charge storage device (504) stays around Vtg2, as illustrated by the waveform shown in FIG. 5(f).

When the voltage (Vpi−Vni) is higher than Vtg2 but lower than Vtg3, the charge storage device (504) is configured as that shown in FIG. 5(c), and the switch control circuit (508) applies a voltage Von as gate voltage-to-source voltage (Vg−Vcg) on the transistor (201) to turn on the transistor, as illustrated by the waveform in FIG. 5(e). When the transistor (201) is turned on, the diode (203) in the electrical switch (205) determines the current flow. The diode (203) is turned on when (Vpi−Vni) is higher than the voltage (Vcg−Vni) on the charge storage device (504), and it will try to change (Vcg−Vni) toward the target voltage Vtg3; the diode (203) is turned off when (Vpi−Vni) is lower than (Vcg−Vni), and it will try to prevent the voltage (Vcg−Vni) on the charge storage device (504) from changing away from Vtg3. When the voltage (Vpi−Vni) is higher than Vtg3 and when the charge storage device (504) is configured as shown in FIG. 5(c), the switch control circuit (508) applies a voltage Voff as the gate-to-source voltage (Vg−Vo) on the transistor (201) to turn off the transistor, trying to prevent the voltage on the charge storage device from changing away from Vtg2, as illustrated by the waveform in FIG. 5(e). In these ways, the electrical switch control circuit (508) turns on the electrical switch (205) when the voltage on the fire line is at a level that can change the voltage applied on the charge storage device (504) toward Vtg3, and turns off the electrical switch (205) when the voltage on the fire line is at a level that can change the voltage applied on the charge storage device (504) away from Vtg3. Therefore, the voltage (Vcg−Vni) on the charge storage device (504) stays around Vtg3, as illustrated by the waveform shown in FIG. 5(f). In these ways, the voltage difference (Vo−Vni) on the third battery (B3) in the charge storage device (504) maintains near Vtg1, as illustrated in FIG. 5(g).

While the preferred embodiments have been illustrated and described herein, other modifications and changes will be evident to those skilled in the art. It is to be understood that there are many other possible modifications and implementations so that the scope of the invention is not limited by the specific embodiments discussed herein. For example, the configurable charge storage device (504) in FIGS. 5(a-c) that comprises three batteries (B1-B3) can be replaced by the configurable charge storage device in FIG. 6(b) that comprises three capacitors (C1-C3) or the one in FIG. 6(c) that comprise two capacitors (C1, C2) and one battery (B3), while serving the same functions. The configurable charge storage device also can have more charge storage components. For example, FIG. 6(d) shows one example that has three capacitors (C1-C3) plus a battery (B4) that is configurable by controlling 9 electrical switches (W1-W9). Configurable charge storage devices with more than 20 charge storage components have tested in our experiments. The electrical switches used in configurable charge storage devices can be diodes, transistors, or other electrical switching components.

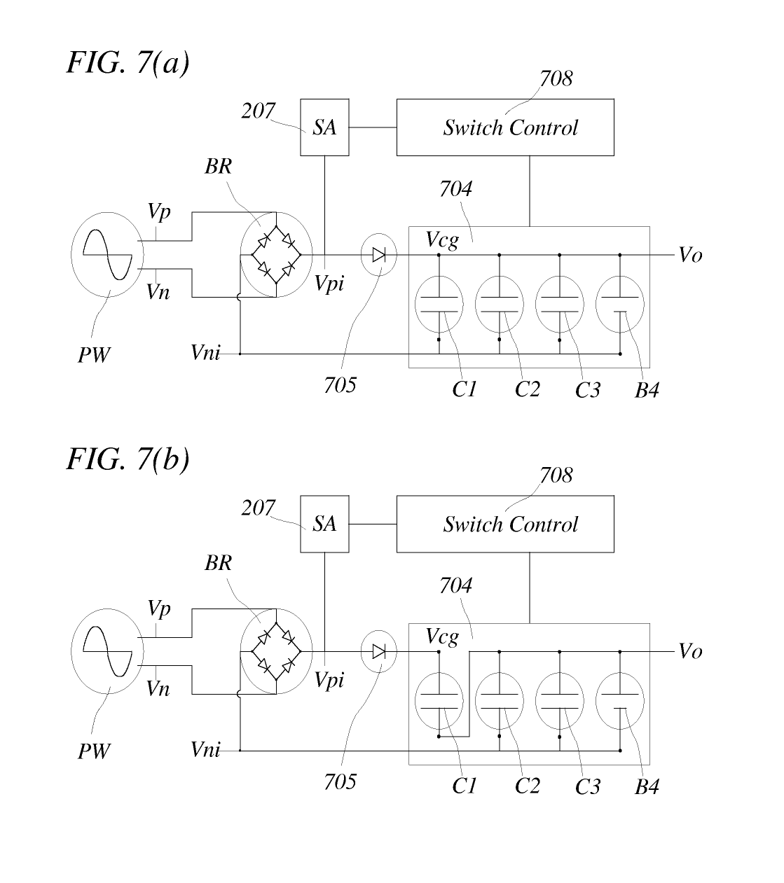

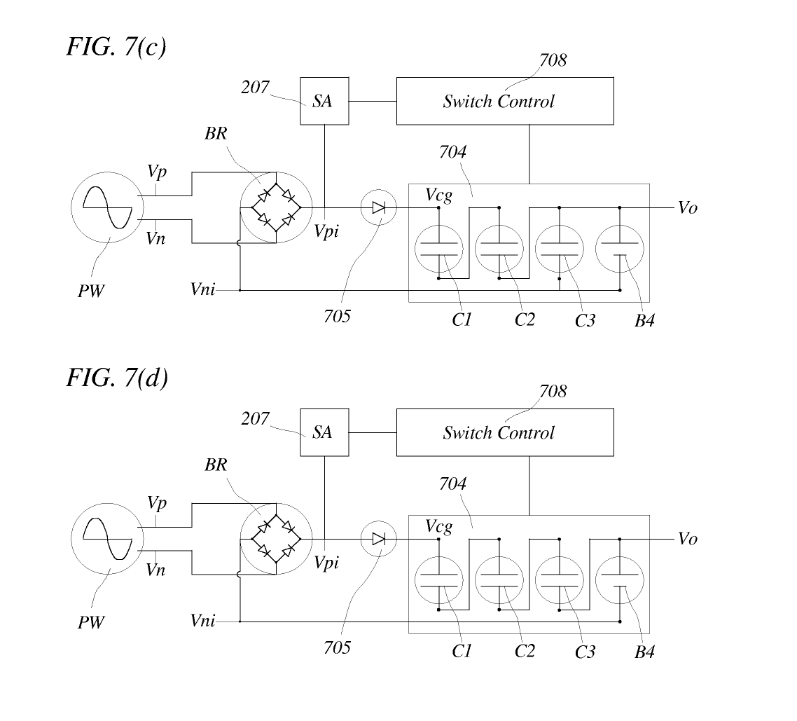

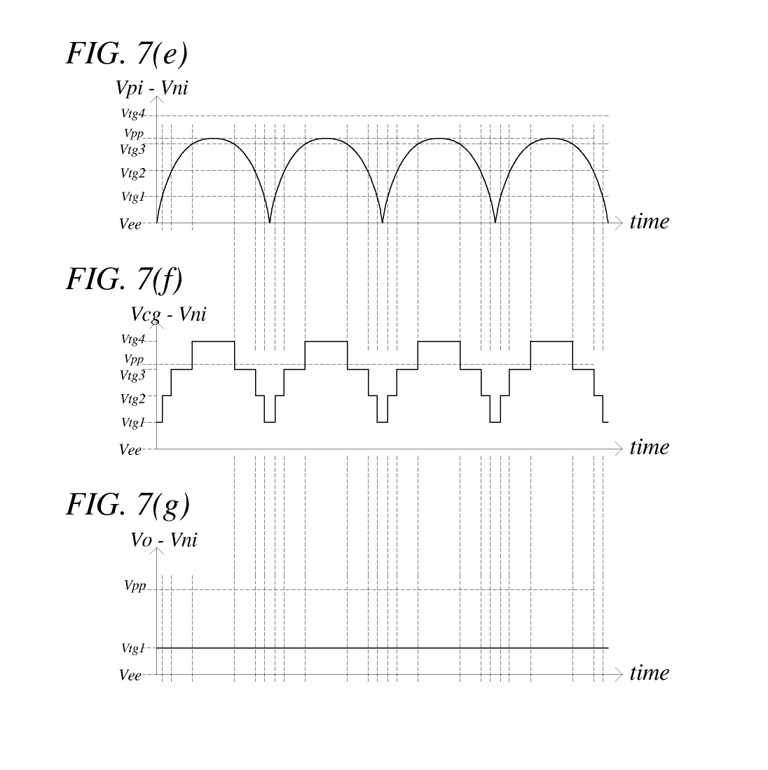

FIGS. 7(a-d) shows simplified symbolic diagrams for an exemplary embodiment of a power converter circuit of the present invention that has similar structures as the embodiment illustrated in FIGS. 5(a-c) except that the charge storage device (504) in FIGS. 5(a-c) is replaced by the configurable charge storage device (704) in FIG. 6(d), the electrical switch (505) is replace by an electrical switch (705) that comprises only one diode, and the switch control circuit (708) controls the operations of the electrical switch (705) by controlling the configuration of the configurable charge storage device (704) without controlling the gate voltage of a transistor.

The charge storage device (704) in FIG. 6(d) comprises three capacitors (C1-C3) plus a battery (B4) that is configurable by controlling 9 electrical switches (W1-W9). When switches W1-W6 are turned on, and when switches W7-W9 are turned off, all 4 charge storage components (C1-C3, B4) in the charge storage device (704) are connected in parallel, as illustrated by FIG. 7(a). When switches W1-W4 and W9 are turned on, and when switches W5-W8 are turned off, C2, C3, and B4 are connected in parallel while C1 is connected in series, as illustrated by FIG. 7(b). When switches W1, W2, W8 and W9 are turned on, and when switches W3-W7 are turned off, C3 and B4 are connected in parallel while C1 and C2 are connected in series with them, as illustrated by FIG. 7(c). When switches W7-W9 are turned on, and when switches W1-W6 are turned off, all 4 charge storage components (C1-C3, B4) in the charge storage device (704) are connected in series, as illustrated by FIG. 7(d). The configuration of this charge storage device (704) is controlled by the switch control circuit (708) that uses a sensing circuit (207) to sense the voltage (Vpi−Vni) between the output terminals of the bridge rectifier (BR) and determines the timing to change the configuration of the configurable charge storage device (704). This electrical switch control circuit (708) turns on or turns off the electrical switch (705) by changing the configuration of the charge storage device (704) instead of controlling a transistor.

When the charge storage device is configured as shown in FIG. 5(a), the electrical switch control circuit (508) turns on the electrical switch (205) when the voltage on the fire line is at a level that can change the voltage applied on the charge storage device toward Vtg1, and turns off the electrical switch (205) when the voltage on the fire line is at a level that can change the voltage applied on said charge storage device away from Vtg1. When the charge storage device is configured as shown in FIG. 5(b), the electrical switch control circuit (508) turns on the electrical switch (205) when the voltage on the fire line is at a level that can change the voltage applied on the charge storage device toward Vtg2, and turns off the electrical switch (205) when the voltage on the fire line is at a level that can change the voltage applied on said charge storage device away from Vtg2. When the charge storage device is configured as shown in FIG. 5(c), the electrical switch control circuit (508) turns on the electrical switch (205) when the voltage on the fire line is at a level that can change the voltage applied on the charge storage device toward Vtg3, and turns off the electrical switch (205) when the voltage on the fire line is at a level that can change the voltage applied on said charge storage device away from Vtg3.

The voltage difference (Vpi−Vni) between the output terminals of the bridge rectifier (BR) in FIGS. 7(a-d) is illustrated by the simplified waveform in FIG. 7(e). The target voltages (Vtg1-Vtg4) are also marked in FIG. 7(e). When the voltage (Vpi−Vni) is lower than Vtg1, the charge storage device (704) is configured as that shown in FIG. 7(a); at this configuration, the diode (705) is turned on when (Vpi−Vni) is higher than the voltage (Vcg−Vni) on the charge storage device (704), and it will change (Vcg−Vni) toward the target voltage Vtg1; the diode (705) is turned off when (Vpi−Vni) is lower than (Vcg−Vni), and it will try to prevent the voltage (Vcg−Vni) on the charge storage device (704) from changing away from Vtg1; therefore, the voltage (Vcg−Vni) applied on the charge storage device stays close to Vtg1, as illustrated in FIG. 7(f). When the voltage (Vpi−Vni) is between Vtg1 and Vtg2, the charge storage device (704) is configured as that shown in FIG. 7(b); at this configuration, the diode (705) is turned on when (Vpi−Vni) is higher than the voltage (Vcg−Vni) on the charge storage device (704), and it will change (Vcg−Vni) toward the target voltage Vtg2; the diode (705) is turned off when (Vpi−Vni) is lower than (Vcg−Vni), and it will try to prevent the voltage (Vcg−Vni) on the charge storage device (704) from changing away from Vtg2; therefore, the voltage (Vcg−Vni) applied on the charge storage device stays close to Vtg2, as illustrated in FIG. 7(f). When the voltage (Vpi−Vni) is between Vtg2 and Vtg3, the charge storage device (704) is configured as that shown in FIG. 7(c); at this configuration, the diode (705) is turned on when (Vpi−Vni) is higher than the voltage (Vcg−Vni) on the charge storage device (704), and it will change (Vcg−Vni) toward the target voltage Vtg3; the diode (705) is turned off when (Vpi−Vni) is lower than (Vcg−Vni), and it will try to prevent the voltage (Vcg−Vni) on the charge storage device (704) from changing away from Vtg3; therefore, the voltage (Vcg−Vni) applied on the charge storage device stays close to Vtg3, as illustrated in FIG. 7(f). When the voltage (Vpi−Vni) is higher than Vtg3, the charge storage device (704) is configured as that shown in FIG. 7(d); at this configuration, the diode (705) is always turned off because (Vpi−Vni) is always lower than the voltage (Vcg−Vni) on the charge storage device (704), and it will try to prevent the voltage (Vcg−Vni) on the charge storage device (704) from changing away from Vtg4; therefore, the voltage (Vcg−Vni) applied on the charge storage device stays close to Vtg4, as illustrated in FIG. 7(f). In these ways, the voltage difference (Vo−Vni) on the battery (B4) in the charge storage device (704) maintains near Vtg1, as illustrated in FIG. 7(g).

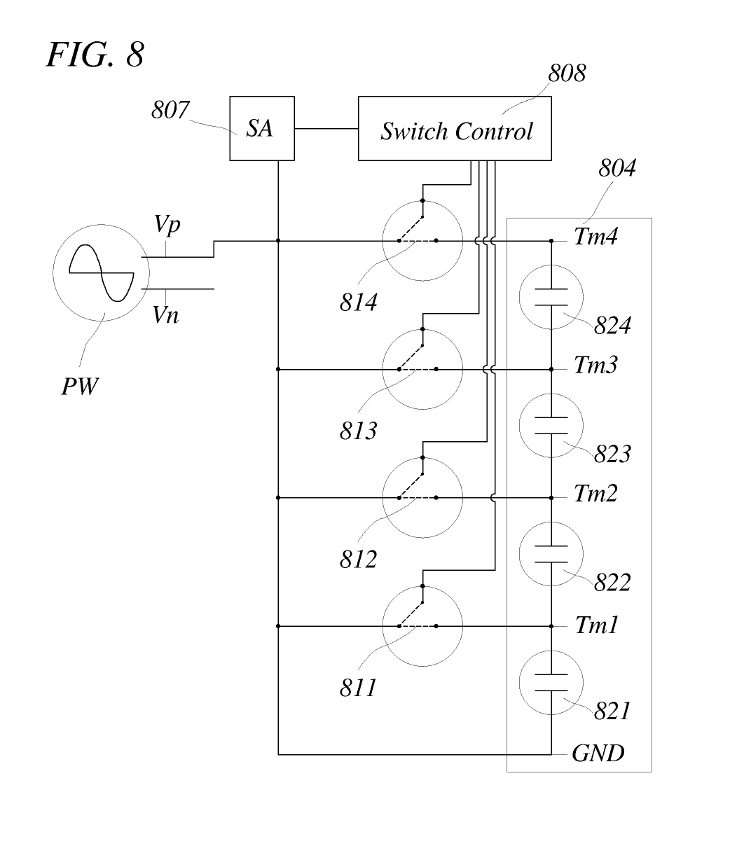

While the preferred embodiments have been illustrated and described herein, other modifications and changes will be evident to those skilled in the art. It is to be understood that there are many other possible modifications and implementations so that the scope of the invention is not limited by the specific embodiments discussed herein. For example, it is possible not to use the diode (705) in the above example, while using part of the bridge rectifier (BR) as the electrical switch. The above examples uses one electrical switch to control the impedance between the electrical input connection that is connected to the fire line of main power source and the charge storage device while we also can use a plurality of electrical switches to serve the purpose. In the above examples the charge storage devices are all two-terminal devices, while we can control a plurality of terminals in the charge storage device, as illustrated by the example in FIG. 8.

FIG. 8 shows a simplified symbolic diagram for an exemplary embodiment of a power converter circuit of the present invention that comprises 4 electrical switches (811-814). The input terminals of those 4 electrical switches (811-814) are all connected to the same electrical input connection that is connected to the fire line of a main power source (PW), and the output terminals of those 4 electrical switches (811-814) are connected to four terminals (Tm1-Tm4) of a charge storage device (804). This charge storage device (804) comprises 4 charge storage components (821-824) connected in series, as shown in FIG. 8.

The electrical switches (811-814) are controlled by a switch control circuit (808) that uses a sensing circuit (807) to sense the voltage (Vp) on the electrical input connection, and determines when to turn on or turn off those electrical switch (811-814). When the voltage on Vp is close to the first target voltage Vtg1, the first electrical switch (811) is turned on so that the voltage on the first terminal (Tm1) of the charge storage device (804) is changed toward Vtg1, and when the voltage on Vp is away from Vtg1, the electrical switch (811) is turned off to prevent the voltage on Tm1 from changing away from Vtg1; when the voltage on Vp is close to the second target voltage Vtg2, the second electrical switch (812) is turned on so that the voltage on the second terminal (Tm2) of the charge storage device (804) is changed toward Vtg1, and when the voltage on Vp is away from Vtg2, the electrical switch (812) is turned off to prevent the voltage on Tm2 from changing away from Vtg2; When the voltage on Vp is close to the third target voltage Vtg3, the third electrical switch (813) is turned on so that the voltage on the third terminal (Tm3) of the charge storage device (804) will change toward Vtg3, and when the voltage on Vp is away from Vtg3, the electrical switch (813) is turned off to prevent the voltage on Tm3 from changing away from Vtg3; When the voltage on Vp is close to the forth target voltage Vtg4, the forth electrical switch (814) is turned on so that the voltage on the forth terminal (Tm4) of the charge storage device (804) is changed toward Vtg4, and when the voltage on Vp is away from Vtg4, the electrical switch (814) is turned off to prevent the voltage on Tm4 from changing away from Vtg4.

While the preferred embodiments have been illustrated and described herein, other modifications and changes will be evident to those skilled in the art. It is to be understood that there are many other possible modifications and implementations so that the scope of the invention is not limited by the specific embodiments discussed herein. A charge converter circuit of the present invention can have one or a plurality of electrical switches that control the voltages on one or a plurality of terminals of a charge storage device. A power converter circuit of the present invention certainly can have a plurality of charge storage devices that are configured in various ways.

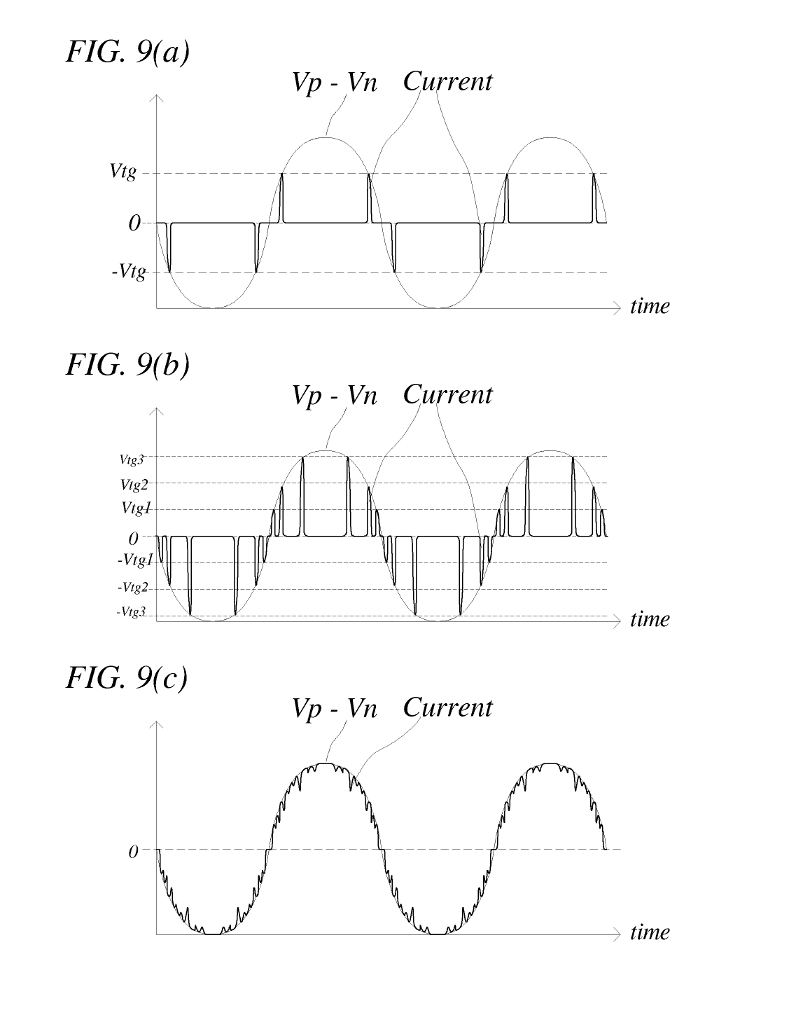

FIG. 9(a) shows the relationship between the current draw from the main power source and the voltage (Vp−Vn) of the main power source for the circuit in FIG. 2(b). For this example, the current peaks when (Vp−Vn) is close to Vtg or −Vtg, as shown in FIG. 9(a). The power factor of this circuit is typically around 0.25, which means that we need to use power factor correction circuits to meet the power factor regulations in order to support high power applications. FIG. 9(b) shows the current-voltage relationship for the example in FIGS. 5(a-c). The current peaks when (Vp−Vn) is close to Vtg1, −Vtg1, Vtg2, −Vtg2, Vtg3, and −Vtg3. With proper control on the level of the target voltages, it is possible to control the amplitudes of those current peaks to be substantially proportional to (Vp−Vn), as shown in FIG. 9(b). When a power converter circuit of the present invention supports multiple target voltages like the examples in FIGS. 5(a-c), in FIG. 7(a-d) and in FIG. 8, the power factor is typically better. It is also possible to have a large number of target voltages to achieve a current-voltage relationship similar to the example in FIG. 9(c), which can achieve power factor better than 0.9.

An electrical power converter circuit of the present invention comprises an electrical power input connection, an electrical charge storage device, an electrical switch, and a switch control circuit; it also may comprise many other components. The electrical power input connection provides electrical connection to the fire line of AC main power source. The electrical charge storage device comprises one charge storage component or a plurality of charge storage components, where a charge storage component is either a capacitor or a battery. The electrical switch controls the electrical impedance between the electrical power input connection and the electrical charge storage device so that, when the electrical switch is turned on, a low impedance electrical current path can be formed from the fire line to the electrical charge storage device, and, when the electrical switch is turned off, the charge storage device is substantially decoupled from the fire line. The electrical switch control circuit turns on or turns off the electrical switch in order to control the voltage on the charge storage device toward a target storage voltage (Vtg) that can be significantly different from peak voltages on the fire line, where the electrical switch control circuit can turn on the electrical switch when the voltage on the fire line is at a level that can change the voltage applied on the charge storage device toward Vtg, and turns off the electrical switch when the voltage on the fire line is at a level that can change the voltage applied on the charge storage device away from Vtg. As shown in the above examples, the electrical switch can comprise one diode and/or one transistor, it can be part of or all of a bridge rectifier, and it can be implemented by many other components. The electrical charge storage device can comprise one or many electrical charge storage components, and it can be configurable using electrical switches. The electrical switch control circuit can control the electrical switch by controlling the gate voltage of a transistor, by changing the configurations of the charge storage device, or by other mechanisms.

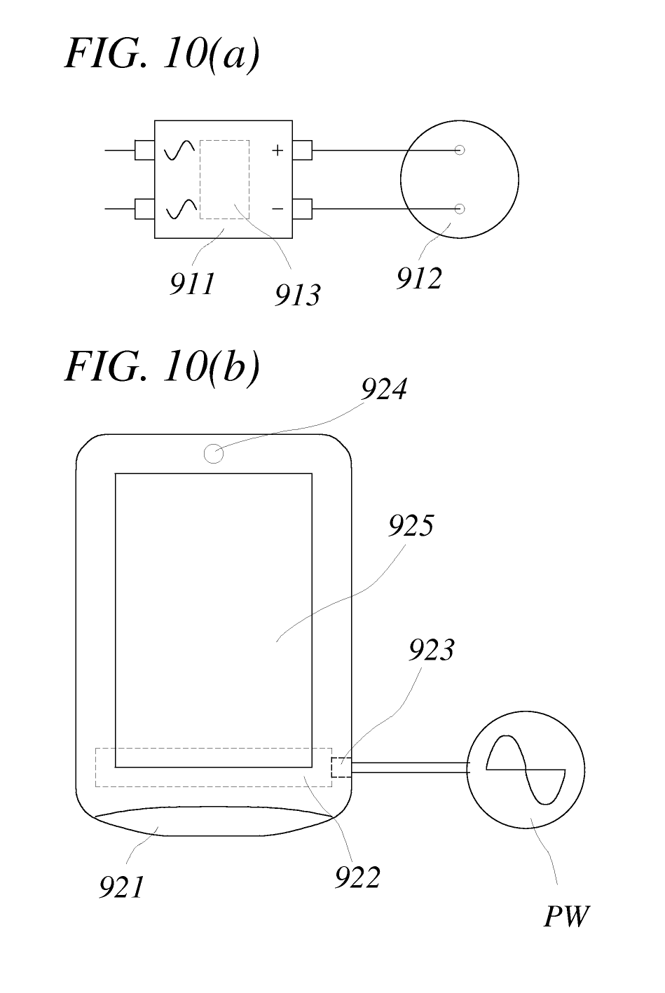

The power converter circuits of the present invention have many advantages over prior art switched-mode power converter circuits. Typically, they can achieve better power efficiency. Many components that are essential for prior art switched-mode power converter circuits, such as large inductors, high voltage transistors, high voltage input capacitors, and PI filters, are no longer needed. Therefore, it is possible to manufacture the electrical switch, the switch control circuit, plus other electrical components on the same semiconductor substrate. It is also possible to package the electrical switch, the switch control circuit, plus other electrical components into a single circuit component. FIG. 10(a) illustrates a preferred embodiment of the present invention that comprises one packaged electrical component (911) plus a capacitor (911). All the electrical components used by the electrical switch and the switch control circuit of the electrical power converter circuit in the above examples can be manufactured on the same semiconductor substrate (913) in the electrical component (911). It is also possible to manufacture them in different semiconductor substrates while packaging them into a single electrical component using multiple chip module packaging technologies. Such power converter circuits are small enough and powerful enough to be embedded into current art battery powered mobile devices. FIG. 10(b) illustrates a preferred embodiment of the present invention when a power converter circuit (922) is completely embedded inside a battery powered mobile device (921). Electrical input connections (923) allow direct connections to AC main power source (PW), and the embedded power converter circuit can charge the battery of the mobile device (921) without the need to use an external battery charger. This battery powered mobile device can have a screen (925) that displays optical images, a camera (924), and it can serve the functions of a computer, a telephone, a camera, or many other functions.

While specific embodiments of the invention have been illustrated and described herein, it is realized that other modifications and changes will occur to those skilled in the art. It is therefore to be understood that the appended claims are intended to cover all modifications and changes as fall within the true spirit and scope of the invention.

What is claimed is:

1. An electrical power converter circuit comprising:
An electrical power input connection providing electrical connection to the fire line of alternate current (AC) main power source;
An electrical charge storage device that comprises one charge storage component or a plurality of charge storage components, where a charge storage component is either a capacitor or a battery;
An electrical switch that controls the electrical impedance between said electrical power input connection and said electrical charge storage device so that, when the electrical switch is turned on, a low impedance electrical current path can be formed from the fire line to the electrical charge storage device, and, when the electrical switch is turned off, said terminal of the charge storage device is substantially decoupled from the fire line; and
An electrical switch control circuit that turns on or turns off said electrical switch in order to control the voltage on said charge storage device toward a target storage voltage (Vtg) that can be significantly different from peak voltages on the fire line, where said electrical switch control circuit can turn on said electrical switch when the voltage on the fire line is at a level that can change the voltage applied on said charge storage device toward Vtg, and turns off the electrical switch when the voltage on the fire line is at a level that can change the voltage applied on said charge storage device away from Vtg.

2. The electrical switch of the electrical power converter circuit in claim 1 comprises one diode.

3. The electrical switch of the electrical power converter circuit in claim 1 comprises one diode and one transistor.

4. The electrical charge storage device of the electrical power converter circuit in claim 1 comprises a plurality of charge storage components, and the connections between those charge storage components can be changed electrically into different configurations.

5. The electrical charge storage device in claim 4 comprises a plurality of electrical switches, and the connections between those charge storage components can be changed electrically by changing the status of those electrical switches.

6. The switch control circuit of the electrical power converter circuit in claim 1 controls the electrical switch in claim 1 by changing the configuration of the electrical storage components in the electrical charge storage device in claim 1.

7. The electrical charge storage device of the electrical power converter circuit in claim 1 comprises a terminal that is coupled through the electrical switch in claim 1 to the electrical input power connection in claim 1, and another terminal of the electrical charge storage device is connected to ground voltage.

8. The electrical power converter circuit in claim 1 comprises a bridge rectifier, the input terminals of this bridge rectifier are coupled to the power lines of AC main power source, while one output terminal of the bridge rectifier is coupled through the electrical switch in claim 1 to one terminal of the electrical charge storage device in claim 1, and the other output terminal of the bridge rectifier is coupled to another terminal of the electrical charge storage device in claim 1.

9. The electrical switch and the switch control circuit of the electrical power converter circuit in claim 1 are manufactured on the same semiconductor substrate.

10. The electrical switch and the switch control circuit of the electrical power converter circuit in claim 1 are packaged in a single circuit component.

11. The electrical power converter circuit in claim 1 is embedded in a battery powered mobile device so that the battery of the battery powered mobile device can be charged from main power source without using an external battery charger.

12. The battery powered mobile device in claim 11 serves the functions of a computer.

13. The battery powered mobile device in claim 11 serves the functions of a telephone.

14. The battery powered mobile device in claim 11 serves the functions of a camera.

15. The battery powered mobile device in claim 11 comprises a screen for displaying optical images.

16. An battery powered electrical mobile device comprising:
Electrical power input connections providing electrical connections to the power lines of AC main power source;
An embedded electrical power converter circuit that charges the battery in said battery powered electrical mobile device using the power provided by the power lines of AC main power source without using other electrical charging devices external to the battery powered electrical mobile device.

17. The battery powered mobile device in claim 16 serves the functions of a computer.

18. The battery powered mobile device in claim 16 serves the functions of a telephone.

19. The battery powered mobile device in claim 16 serves the functions of a camera.

20. The battery powered mobile device in claim 16 comprises a screen for displaying optical images.
